(19) United States
(12) Patent Application Publication
(10) Pub. No.: US 2008/0066500 A1
(43) Pub. Date: Mar. 20, 2008

(54) Cable lock that is opened forcibly

(76) Inventor: Shun-Chang Su, Changhua Hsien (TW)

Correspondence Address: Steven Horowitz;Suite 700, 295 Madison Avenue, New York, NY, 10017, US

(21) Appl. No.: 11/522,011

(22) Filed: Sep. 15, 2006

(51) Int. Cl. E05B 37/02

(52) U.S. Cl. 70/21

(57) ABSTRACT

A cable lock includes a housing, a flexible cable, a number lock mechanism, a first locking seat, a key lock mechanism, and a second locking seat. Thus, the cable is locked and unlocked by the number lock mechanism and the key lock mechanism respectively, so that a user can lock and unlock the number lock mechanism to open and close the cable lock, and the inspector of the customs can use a specific key to lock and unlock the key lock mechanism to open and close the cable lock, thereby facilitating the user and the inspector of the customs operating the cable lock.

### FIELD OF THE INVENTION

The present invention relates to a cable lock and, more particularly, to a cable lock for a luggage, a cabinet, a safety box and the like.

### BACKGROUND OF THE INVENTION AND DESCRIPTION OF THE PRIOR ART

A conventional lock for a luggage comprises a lock body, and a shackle mounted on the lock body for locking the luggage. However, when the luggage is checked by an inspector of the customs, the inspector cannot unlock the lock to open the luggage if the user is absent, so that the inspector has to break the lock forcibly for checking the items contained in the luggage, thereby greatly causing inconvenience to the user and the inspector.

### BRIEF SUMMARY OF THE INVENTION

A cable lock includes a housing, a flexible cable, a number lock mechanism, a first locking seat, a key lock mechanism, and a second locking seat. Thus, the cable is locked and unlocked by the number lock mechanism and the key lock mechanism respectively, so that a user can lock and unlock the number lock mechanism to open and close the cable lock, and the inspector of the customs can use a specific key to lock and unlock the key lock mechanism to open and close the cable lock, thereby facilitating the user and the inspector of the customs operating the cable lock.

### IMPORTANT OBJECTS AND ADVANTAGES

The primary objective of the present invention is to provide a cable lock that is opened forcibly.

Another objective of the present invention is to provide a cable lock, wherein the cable of the cable lock is locked and unlocked by the number lock mechanism and the key lock mechanism respectively, so that a user can lock and unlock the number lock mechanism to open and close the cable lock, and the inspector of the customs can use a specific key to lock and unlock the key lock mechanism to open and close the cable lock, thereby facilitating the user and the inspector of the customs operating the cable lock.

A further objective of the present invention is to provide a cable lock, wherein the specified key is held by the inspector of the customs, so that the inspector can directly unlock the key lock mechanism of the cable lock by the specified key so as to open and check the luggage locked by the cable lock without having to break the cable lock for checking the luggage.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a cable lock in accordance with the preferred embodiment of the present invention.

FIG. 2 is an exploded perspective view of the cable lock as shown in FIG. 1.

FIG. 3 is a plan cross-sectional view of the cable lock as shown in FIG. 1.

FIG. 4 is a schematic operational view of the cable lock as shown in FIG. 3.

FIG. 5 is a schematic operational view of the cable lock as shown in FIG. 3.

### DETAILED DESCRIPTION OF THE INVENTION

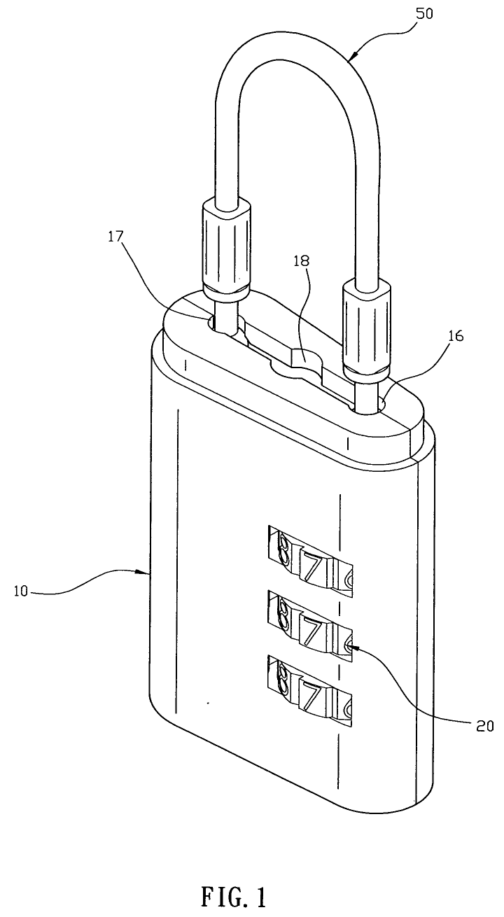

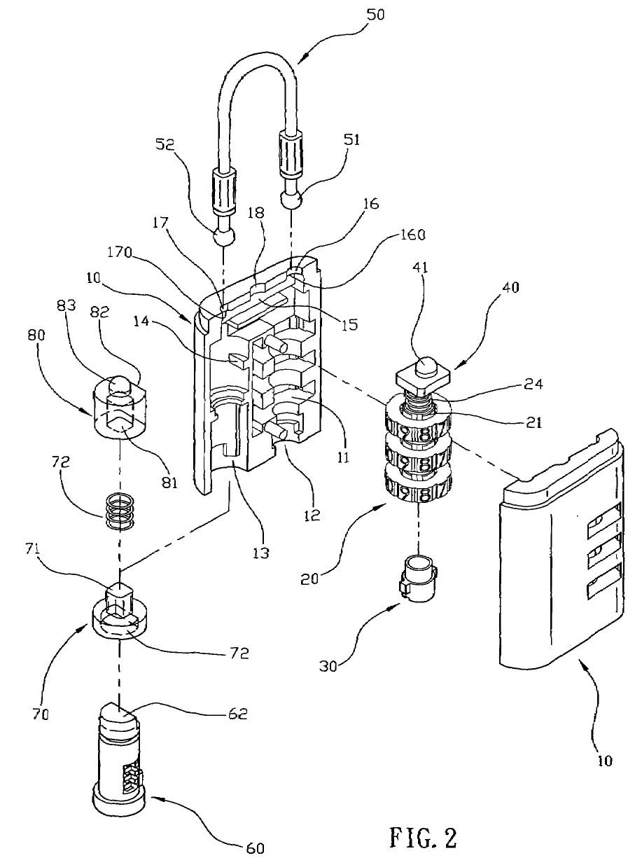

Referring to the drawings and initially to FIGS. 1-3, a cable lock for a luggage in accordance with the preferred embodiment of the present invention comprises a housing 10 having an upper portion formed with a slideway 15 having a passage 18, a flexible cable 50 mounted on the housing 10 and having a first end provided with a spherical first movable member 51 movable in the slideway 15 of the housing 10 to pass through the passage 18 of the housing 10 and a second end provided with a spherical second movable member 52 movable in the slideway 15 of the housing 10 to pass through the passage 18 of the housing 10, a number lock mechanism 20 mounted on the housing 10, a first locking seat 40 controlled by the number lock mechanism 20 and provided with a semi-spherical locking protrusion 41 extended into the slideway 15 of the housing 10 and detachably rested on the first movable member 51 of the cable 50 to limit movement of the first movable member 51 of the cable 50, a key lock mechanism 60 mounted on the housing 10, and a second locking seat 80 controlled by the key lock mechanism 60 and provided with a semi-spherical locking protrusion 83 extended into the slideway 15 of the housing 10 and detachably rested on the second movable member 52 of the cable 50 when the key lock mechanism 60 is disposed at a locked state to limit movement of the second movable member 52 of the cable 50.

Thus, the locking protrusion 41 of the first locking seat 40 presses the first movable member 51 of the cable 50 when the number lock mechanism 20 is disposed at a locked state to lock the first movable member 51 of the cable 50, and the locking protrusion 83 of the second locking seat 80 presses the second movable member 52 of the cable 50 when the key lock mechanism 60 is disposed at a locked state to lock the second movable member 52 of the cable 50.

The housing 10 has a first side formed with a first chamber 11 connected to the slideway 15 to receive the number lock mechanism 20 and the first locking seat 40 and a second side formed with a second chamber 13 connected to the slideway 15 to receive the key lock mechanism 60 and the second locking seat 80. The first chamber 11 of the housing 10 has a lower portion formed with a mounting hole 12 for mounting a press button 30 which is located under the number lock mechanism 20, so that when the number lock mechanism 20 is disposed at an unlocked state, the press button 30 can be pressed to adjust the code of the number lock mechanism 20. The second chamber 13 of the housing 10 has an upper portion formed with a limit flange 14.

The slideway 15 of the housing 10 has a first end formed with a first locking hole 16 for locking the first movable member 51 of the cable 50 and a second end formed with a second locking hole 17 for locking the second movable member 52 of the cable 50. The first locking hole 16 of the housing 10 has a side formed with an arc-shaped recessed limit portion 160 to limit the first movable member 51 of the cable 50 by a push force of the locking protrusion 41 of the first locking seat 40, and the second locking hole 17 of the housing 10 has a side formed with an arc-shaped recessed limit portion 170 to limit the second movable member 52 of the cable 50 by a push force of the locking protrusion 83 of the second locking seat 80. The passage 18 of the housing 10 is located at a mediate portion of the slideway 15 between the first locking hole 16 and the second locking hole 17. Thus, each of the first movable member 51 and the second movable member 52 of the cable 50 is extended into and outwardly from the slideway 15 of the housing 10 through the passage 18 of the housing 10.

The number lock mechanism 20 includes a number lock core 21, a mandrel 22 movably mounted on the number lock core 21, and an elastic member 24 mounted on the mandrel 22 and biased between the number lock core 21 and the first locking seat 40 to push the locking protrusion 41 of the first locking seat 40 toward the first movable member 51 of the cable 50.

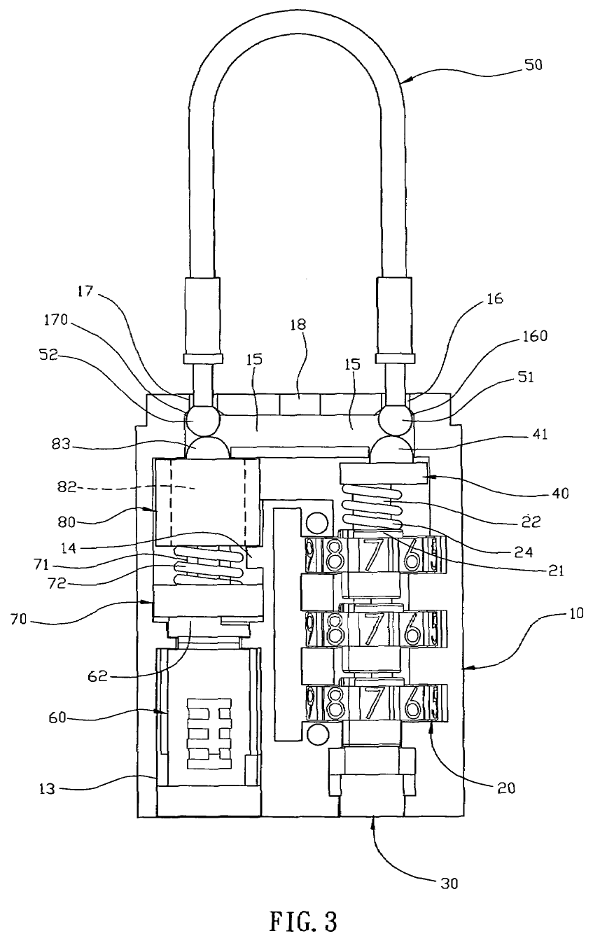

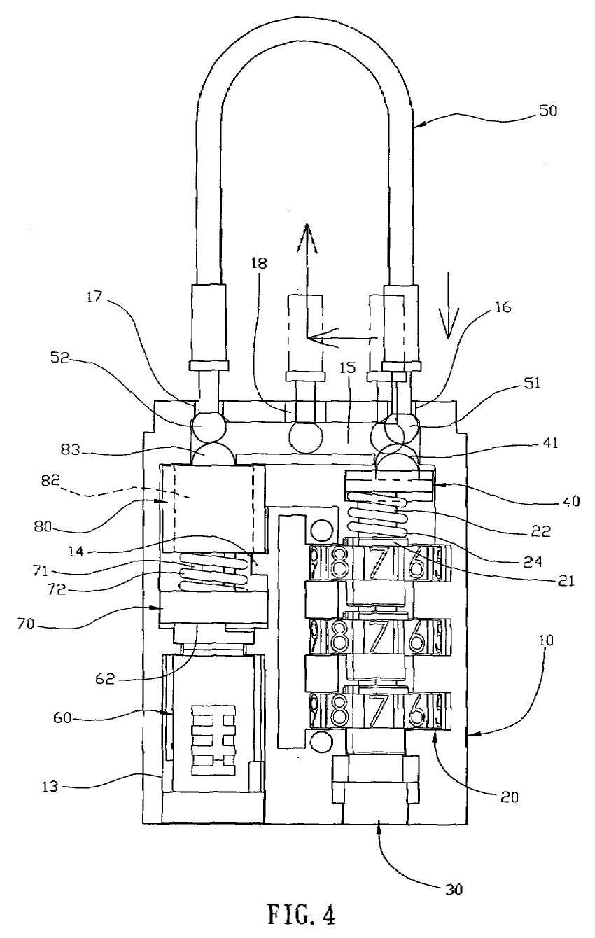

The first locking seat 40 is located above the number lock mechanism 20 and mounted on the mandrel 22 of the number lock mechanism 20. Thus, when the number lock mechanism 20 is disposed at an unlocked state, the mandrel 22 of the number lock mechanism 20 is movable relative to the number lock core 21, so that the first locking seat 40 is movable relative to the number lock mechanism 20 between a first position as shown in FIG. 3 where the locking protrusion 41 of the first locking seat 40 is rested on the first movable member 51 of the cable 50 to limit movement of the first movable member 51 of the cable 50, and a second position as shown in FIG. 4 where the locking protrusion 41 of the first locking seat 40 is pressed by the first movable member 51 of the cable 50 to allow movement of the first movable member 51 of the cable 50.

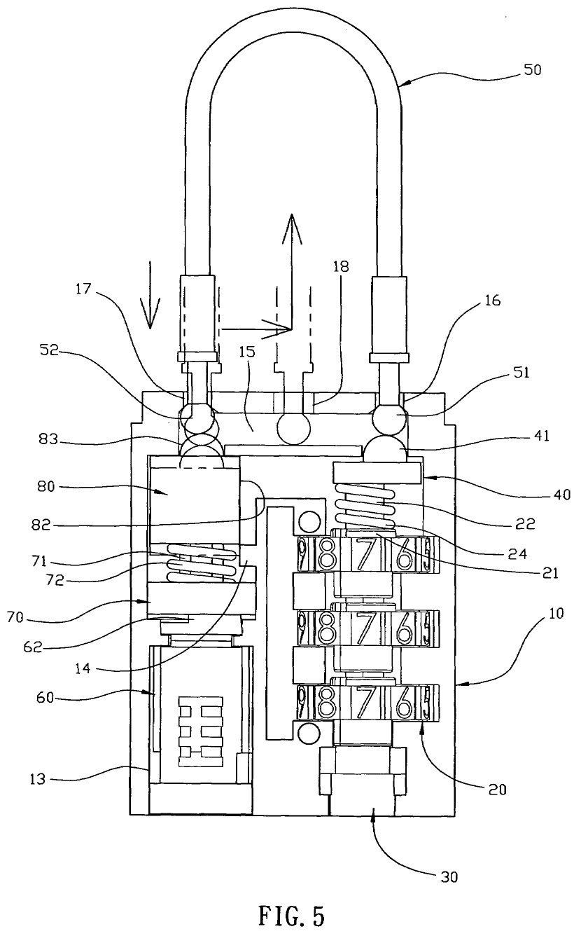

The second locking seat 80 is rotatably mounted in the second chamber 13 of the housing 10 and located above the limit flange 14 of the housing 10. The second locking seat 80 has a side formed with a flattened face 82. Thus, the second locking seat 80 is rotatable relative to the housing 10 between a first position as shown in FIG. 3 where the flattened face 82 of the second locking seat 80 is separated from the limit flange 14 of the housing 10 and the bottom 84 of the second locking seat 80 is limited by the limit flange 14 of the housing 10 so that the second locking seat 80 is positioned in the housing 10, and a second position as shown in FIG. 5 where the flattened face 82 of the second locking seat 80 is aligned with the limit flange 14 of the housing 10 so that the second locking seat 80 is released from the limit flange 14 of the housing 10 and is axially movable relative to the housing 10.

The cable lock further comprises a drive member 70 rotatably mounted in the second chamber 13 of the housing 10 and having a first end connected to the second locking seat 80 to rotate the second locking seat 80 and a second end connected to and rotated by the key lock mechanism 60, and an elastic member 72 biased between the second locking seat 80 and the drive member 70 to push the locking protrusion 83 of the second locking seat 80 toward the second movable member 52 of the cable 50. The second locking seat 80 has a bottom formed with a fixing hole 81. The first end of the drive member 70 is provided with a drive post 71 inserted into the fixing hole 81 of the second locking seat 80 so that the second locking seat 80 is rotatable by the drive member 70. The second end of the drive member 70 is formed with a fixing bore 72. The key lock mechanism 60 includes a key lock core 62 inserted into the fixing bore 72 of the drive member 70 so that the drive member 70 is rotatable by the key lock core 62 of the key lock mechanism 60. Thus, when the key lock core 62 of the key lock mechanism 60 is rotated by a specific key, the drive member 70 is rotated by the key lock core 62 of the key lock mechanism 60 to rotate the second locking seat 80.

As shown in FIG. 4, when the number lock mechanism 20 is disposed at an unlocked state, the mandrel 22 of the number lock mechanism 20 is movable relative to the number lock core 21, so that the first locking seat 40 is movable relative to the number lock mechanism 20. In such a manner, the locking protrusion 41 of the first locking seat 40 can be pressed downward by the first movable member 51 of the cable 50 to allow movement of the first movable member 51 of the cable 50, so that the first movable member 51 of the cable 50 is unlocked and freely movable in the slideway 15 of the housing 10 to pass through the passage 18 of the housing 10. Thus, the first movable member 51 of the cable 50 can be pulled outwardly from the housing 10 through the passage 18 of the housing 10.

As shown in FIG. 5, when the key lock core 62 of the key lock mechanism 60 is rotated by a specific key, the key lock mechanism 60 is disposed at an unlocked state, so that the drive member 70 is rotated by the key lock core 62 of the key lock mechanism 60 to rotate the second locking seat 80. Thus, the second locking seat 80 is rotatable relative to the housing 10 until the flattened face 82 of the second locking seat 80 is aligned with the limit flange 14 of the housing 10 so that the second locking seat 80 is released from the limit flange 14 of the housing 10 and is axially movable relative to the housing 10. In such a manner, the locking protrusion 83 of the second locking seat 80 can be pressed downward by the second movable member 52 of the cable 50 to allow movement of the second movable member 52 of the cable 50, so that the second movable member 52 of the cable 50 is unlocked and freely movable in the slideway 15 of the housing 10 to pass through the passage 18 of the housing 10. Thus, the second movable member 52 of the cable 50 can be pulled outwardly from the housing 10 through the passage 18 of the housing 10.

Accordingly, the cable 50 of the cable lock is locked and unlocked by the number lock mechanism 20 and the key lock mechanism 60 respectively, so that a user can lock and unlock the number lock mechanism 20 to open and close the cable lock, and the inspector of the customs can use a specific key to lock and unlock the key lock mechanism 60 to open and close the cable lock, thereby facilitating the user and the inspector of the customs operating the cable lock. In addition, the specified key is held by the inspector of the customs, so that the inspector can directly unlock the key lock mechanism 60 of the cable lock by the specified key so as to open and check the luggage locked by the cable lock without having to break the cable lock for checking the luggage.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A cable lock, comprising:
a housing having an upper portion formed with a slideway having a passage;
a flexible cable mounted on the housing and having a first end provided with a first movable member movable in the slideway of the housing to pass through the passage of the housing and a second end provided with a second movable member movable in the slideway of the housing to pass through the passage of the housing;
a number lock mechanism mounted on the housing;
a first locking seat controlled by the number lock mechanism and provided with a locking protrusion extended into the slideway of the housing and detachably rested on the first movable member of the cable to limit movement of the first movable member of the cable;
a key lock mechanism mounted on the housing;
a second locking seat controlled by the key lock mechanism and provided with a locking protrusion extended into the slideway of the housing and detachably rested on the second movable member of the cable to limit movement of the second movable member of the cable.

2. The cable lock in accordance with claim 1, wherein the housing has a first side formed with a first chamber connected to the slideway to receive the number lock mechanism and the first locking seat and a second side formed with a second chamber connected to the slideway to receive the key lock mechanism and the second locking seat.

3. The cable lock in accordance with claim 2, wherein the first chamber of the housing has a lower portion formed with a mounting hole for mounting a press button which is located under the number lock mechanism, so that when the number lock mechanism is disposed at an unlocked state, the press button can be pressed to adjust the code of the number lock mechanism.

4. The cable lock in accordance with claim 2, wherein the slideway of the housing has a first end formed with a first locking hole for locking the first movable member of the cable and a second end formed with a second locking hole for locking the second movable member of the cable.

5. The cable lock in accordance with claim 4, wherein the first locking hole of the housing has a side formed with an arc-shaped recessed limit portion to limit the first movable member of the cable by a push force of the locking protrusion of the first locking seat, and the second locking hole of the housing has a side formed with an arc-shaped recessed limit portion to limit the second movable member of the cable by a push force of the locking protrusion of the second locking seat.

6. The cable lock in accordance with claim 4, wherein the passage of the housing is located at a mediate portion of the slideway between the first locking hole and the second locking hole.

7. The cable lock in accordance with claim 1, wherein the number lock mechanism includes a number lock core, and a mandrel movably mounted on the number lock core, and the first locking seat is mounted on the mandrel of the number lock mechanism.

8. The cable lock in accordance with claim 7, wherein when the number lock mechanism is disposed at an unlocked state, the mandrel of the number lock mechanism is movable relative to the number lock core, so that the first locking seat is movable relative to the number lock mechanism between a first position where the locking protrusion of the first locking seat is rested on the first movable member of the cable to limit movement of the first movable member of the cable, and a second position where the locking protrusion of the first locking seat is pressed by the first movable member of the cable to allow movement of the first movable member of the cable.

9. The cable lock in accordance with claim 7, wherein the number lock mechanism further includes an elastic member mounted on the mandrel and biased between the number lock core and the first locking seat to push the locking protrusion of the first locking seat toward the first movable member of the cable.

10. The cable lock in accordance with claim 2, wherein the second chamber of the housing has an upper portion formed with a limit flange, the second locking seat has a side formed with a flattened face, and the second locking seat is rotatable relative to the housing between a first position where the flattened face of the second locking seat is separated from the limit flange of the housing and a bottom of the second locking seat is limited by the limit flange of the housing so that the second locking seat is positioned in the housing, and a second position where the flattened face of the second locking seat is aligned with the limit flange of the housing so that the second locking seat is released from the limit flange of the housing and is axially movable relative to the housing.

11. The cable lock in accordance with claim 10, wherein the second locking seat is rotatably mounted in the second chamber of the housing and located above the limit flange of the housing.

12. The cable lock in accordance with claim 2, further comprising a drive member rotatably mounted in the second chamber of the housing and having a first end connected to the second locking seat to rotate the second locking seat and a second end connected to and rotated by the key lock mechanism.

13. The cable lock in accordance with claim 12, further comprising an elastic member biased between the second locking seat and the drive member to push the locking protrusion of the second locking seat toward the second movable member of the cable.

14. The cable lock in accordance with claim 12, wherein the second locking seat has a bottom formed with a fixing hole, and the first end of the drive member is provided with a drive post inserted into the fixing hole of the second locking seat so that the second locking seat is rotatable by the drive member.

15. The cable lock in accordance with claim 12, wherein the second end of the drive member is formed with a fixing bore, and the key lock mechanism includes a key lock core inserted into the fixing bore of the drive member so that the drive member is rotatable by the key lock core of the key lock mechanism.

16. The cable lock in accordance with claim 1, wherein the locking protrusion of the first locking seat presses the first movable member of the cable when the number lock mechanism is disposed at a locked state to lock the first movable member of the cable, and the locking protrusion of the second locking seat presses the second movable member of the cable when the key lock mechanism is disposed at a locked state to lock the second movable member of the cable.

17. The cable lock in accordance with claim 1, wherein the first movable member of the cable has a spherical shape, and the second movable member of the cable has a spherical shape.

18. The cable lock in accordance with claim 1, wherein the locking protrusion of the first locking seat has a semi-spherical shape, and the locking protrusion of the second locking seat has a semi-spherical shape.

19. The cable lock in accordance with claim 1, wherein each of the first movable member and the second movable member of the cable is extended into and outwardly from the slideway of the housing through the passage of the housing.

20. The cable lock in accordance with claim 1, wherein the first locking seat is located above the number lock mechanism.
